(19) United States
(12) Patent Application Publication
(10) Pub. No.: US 2014/0184600 A1
(43) Pub. Date: Jul. 3, 2014

(54) STEREOSCOPIC VOLUME RENDERING IMAGING SYSTEM

(71) Applicant: GENERAL ELECTRIC COMPANY, Schenectady, NY (US)

(72) Inventor: Erik Normann Steen, Olso (NO)

(73) Assignee: GENERAL ELECTRIC COMPANY, Schenectady, NY (US)

(21) Appl. No.: 13/729,822

(22) Filed: Dec. 28, 2012

(51) Int. Cl. G06T 15/00

(52) U.S. Cl. CPC G06T 15/00
USPC 345/424

(57) ABSTRACT

A method and apparatus generate volume rendered images of internal anatomical imaging data, wherein the volume rendered images are taken along different viewing vectors. A stereoscopic volume rendered image is generated based on the volume rendered images. In one implementation, depth values for pixels of each of the volume rendered images are determined and the pixels are assigned with colors based on the determined depth values to provide the stereoscopic image has color-coded depth representation. In one implementation, shadows are added to the stereoscopic volume rendered image.

### BACKGROUND

Volume rendering is sometimes used to visualize and interact with three-dimensional data in medical imaging. Stereoscopic volume rendering is also used to enhance visualization of the three-dimensional data. Existing stereoscopic volume rendering devices and methods may lack adequate clarity without specialized eyewear and may offer limited perception cues.

### BRIEF DESCRIPTION OF THE DRAWINGS

FIG. 1 is a schematic illustration of an example stereoscopic volume rendering image system.

FIG. 2 is a flow diagram of an example method that may be carried out by the system of FIG. 1.

FIG. 3 is a diagram illustrating an example of generation of volume rendered images at different viewing angles.

FIG. 4 is a schematic diagram illustrating row interlacing to generate a stereoscopic image.

FIG. 5 are diagrams illustrating an example use of left and right volume rendered images for a single stereoscopic volume rendered image.

FIG. 6 is a schematic illustration of another example of a stereoscopic volume rendering image system.

FIG. 7 is a flow diagram of an example method that may be carried out by the system of FIG. 6.

FIG. 8 is a flow diagram of an example method for generating volume shadows.

FIG. 9 is a diagram illustrating an example of determining whether a pixel of a stereoscopic volume rendered image lies within a shadow, wherein the pixel lies outside the shadow.

FIG. 10 is a diagram illustrating an example of determining whether a pixel of a stereoscopic volume rendered image lies within a shadow, wherein the pixel lies within the shadow.

FIGS. 11-15 are diagrams illustrating one example of the addition of a shadow volume rendered image.

### DETAILED DESCRIPTION OF THE EXAMPLE EMBODIMENTS

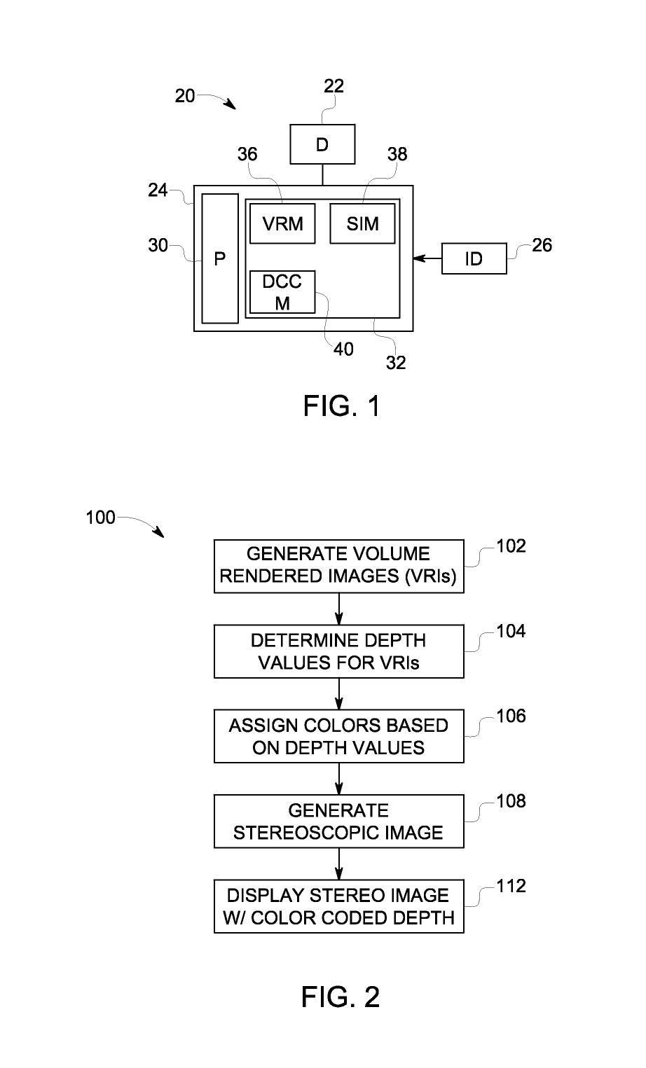

FIG. 1 schematically illustrates an example stereoscopic volume rendering image system 20. In one implementation, stereoscopic volume rendering image system 20 is configured for use in medical imaging in medical diagnosis. As will be described hereafter, stereoscopic volume rendering image system 20 provides greater perceptual cues to enhance visualization and interaction with three-dimensional data. As will be described hereafter, in some implementations, stereoscopic volume rendering image system 20 facilitates useful visualization for observers with and without specialized eyewear. Stereoscopic volume rendering image system 20 comprises display 22 and imaging engine 24.

Display 22 comprises a monitor, screen, panel or other device configured to display stereoscopic volume rendered images or 3-D images produced by engine 24. Display 22 may be incorporated as part of a medical imaging system, a stationary monitor, a television, or a portable electronic device such as a tablet computer, a personal data assistant (PDA), a flash memory reader, a smart phone and the like. Display 22 receives display generation signals from engine 24 in any wired or wireless fashion. Display 22 may be in communication with engine 24 directly, across a local area network or across a wide area network such as the Internet.

Imaging engine 24 comprises one or more processing units configured to carry out instructions contained in a memory so as to produce or generate stereoscopic images of volume rendered images which are based upon imaging data 26. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, engine 24 may be embodied as part of one or more application-specific integrated circuits (ASICs). Unless otherwise specifically noted, engine 24 is not limited to any specific combination of hardware circuitry and software, nor to any particular source for the instructions executed by the processing unit.

Imaging data 26 comprises three-dimensional data. In one implementation, imaging data 26 comprises internal anatomical imaging data for use in medical imaging and medical diagnosis. In one implementation, imaging data 26 comprises ultrasound data provided by one or more ultrasound probes having a two-dimensional array of ultrasound transducer elements facilitating the creation of imaging data from multiple viewing angles or viewing vectors. In other implementations, imaging data 24 may comprise volume data such as data provided by x-ray computer tomography (CT) scanners, positron emission tomography (PET) scanners and the like.

In the example illustrate, imaging engine 24 comprises processing unit 30 and memory 32. Processing unit 30 comprises one or more processing units to carry out instructions contained in memory 32.

Memory 32 comprises a non-transient or non-transitory computer-readable medium or persistent storage device containing program or code for directing the operation processing unit 30 in the generation of stereoscopic volume rendered images. Memory 32 may additionally include data storage portions for storing and allowing retrieval of data such as image data 26 as well as data produced from image data 26. Memory 32 comprises volume rendering module 36, stereoscopic imaging module 38 and depth color coding module 40.

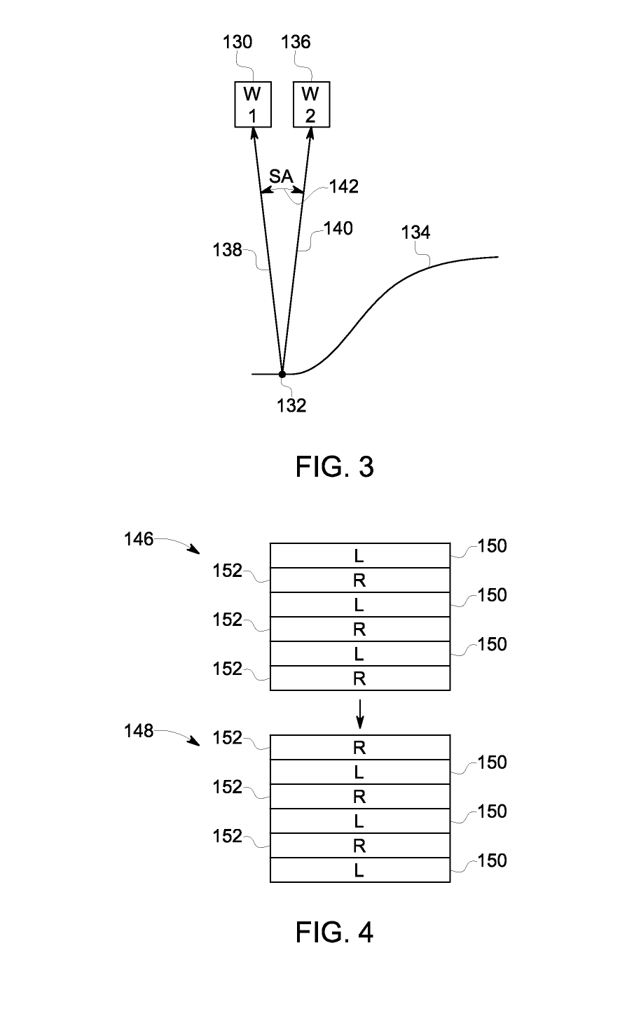

Volume rendering module 36, stereoscopic imaging module 38 and depth color coding module 40 comprise code or computer-readable programming stored on memory 32 for directing processing unit 30 to carry out the example stereoscopic volume rendering imaging method 100 shown in FIG. 2. As indicated by step 102 in FIG. 2, volume rendering module 36 directs processing unit 30 in the generation of volume rendered images from image data 26. The volume rendered images produced at the instruction of module 36 may be generated using an image-based volume rendering technique such as volume ray casting. As shown by FIG. 3, the volume rendered images include a left volume rendered image 130 of a voxel 132 on an internal anatomical structure 134 and a right volume rendered image 136 of the voxel 132. Images 130, 136 are taken along viewing vectors 138, 140, respectively, separated by a non-zero separation angle (SA) 142. In one implementation, the separation angle 142 is no greater than four degrees and nominally between two and three degrees. As a result, the stereoscopic image generated from such left and right images 130, 136 may offer enhanced visualization with specialized eyewear such as 3-D glasses while the same time possessing sufficient clarity to be visually useful to those without specialized eyewear for 3-D stereoscopic viewing. This is particularly important when using imaging equipment during an intervention in an operating theater as parts of the medical staff may not be able to wear glasses while they still need to observe the volume rendered images in real time. In other implementations, the separation angle 142 may be greater than four degrees. In some implementations, the volume rendering produced by module 36 may additionally include gradient shading and other volume rendering visualization enhancements.

Depth color coding module 40 directs processing unit 30 to encode depth in the volume rendered image as color. As indicated by step 104 in FIG. 2, depth color coding module 40 determines a depth value for each voxel of each of the volume rendered images produced in step 102. The depth values represent distances between the viewing planes (planes orthogonal or perpendicular to the viewing vectors 138, 140) and an explicitly or implicitly defined surface. The surface may be defined explicitly using hard thresholding. In other implementations, the surfaces may be defined implicitly using a weighted voxel center of gravity along each ray or viewing vector 138, 142, wherein each voxel location is weighted by an opacity value (intensity).

As indicated by step 106, depth color coding module 40 directs processing 30 to assign colors to each of the pixels of the volume rendered image based upon the determined depth values. In particular, the depth value and the intensity value computed by processing unit 30 in the volume rendering process is fed through a depth color map which translates depth and intensity into a color. In one implementation, a bronze color is employed for surfaces close to the view plane while blue colors are used for structures further away from the view plane. The depth encoded colors added to the volume rendered images provide additional perception cues when such volume rendered images are combined to form a stereoscopic image. This combination is particularly useful when the user either has limitations with color perception or limited ability to perceive depth from stereo images.

Stereoscopic imaging module 38 comprises code or portions of code in memory 32 configured to direct processing unit or processor 30 to generate a stereoscopic image based upon the volume rendered images having color encoded depth for presentation on display 22. As indicated by step 108 in FIG. 2, stereoscopic imaging module 38 generates a stereoscopic image for viewing. As indicated by step 112, the generated stereoscopic image having color-coded depth is presented on display 22.

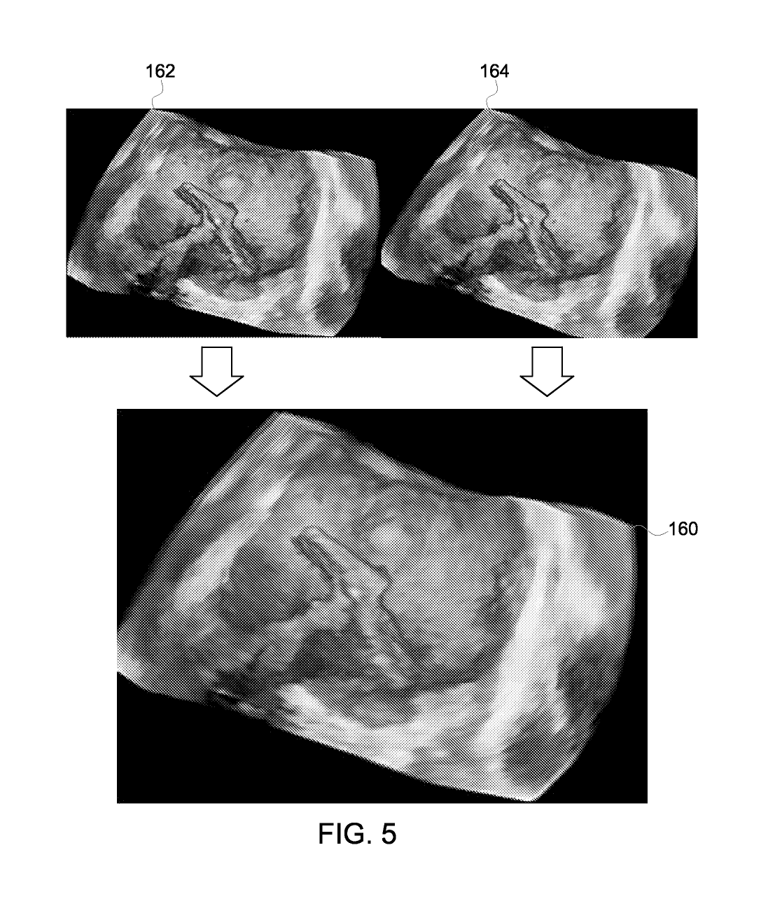

FIG. 4 schematically illustrates one method by which a stereoscopic image may be generated and displayed. As shown by FIG. 4, the left and right images 130, 136, after having depth color encoding, are interleaved on a line-by-line or row basis (row-interlaced stereo). As shown by FIG. 4, display 22 presents interlaced displays 146, 148 having even/odd lines 150, 152 with alternating left/right stereo orientations. FIG. 5 illustrates an example color encoded stereoscopic image 160 generated by processing unit 30 under the direction of stereoscopic image module 38 by line interlacing left color encoded volume rendered image 162 with right color encoded volume rendered image 164. In such an implementation, display 22 may apply different polarizing filters for each scan line so that person wearing (circular) polarized glasses is provided with a stereoscopic visualization of the volume rendered images. In other implementations, the volume rendered images may be presented on display 22 using frame interleaving, wherein each odd frame comprises a left volume rendered image (such as volume rendered image 162) while each even frame comprises a right volume rendered image (such as volume rendered image 164) and wherein display 22 flips the polarity of the polarizing filters for every new image (nominally with a display refresh rate of at least 100 Hz).

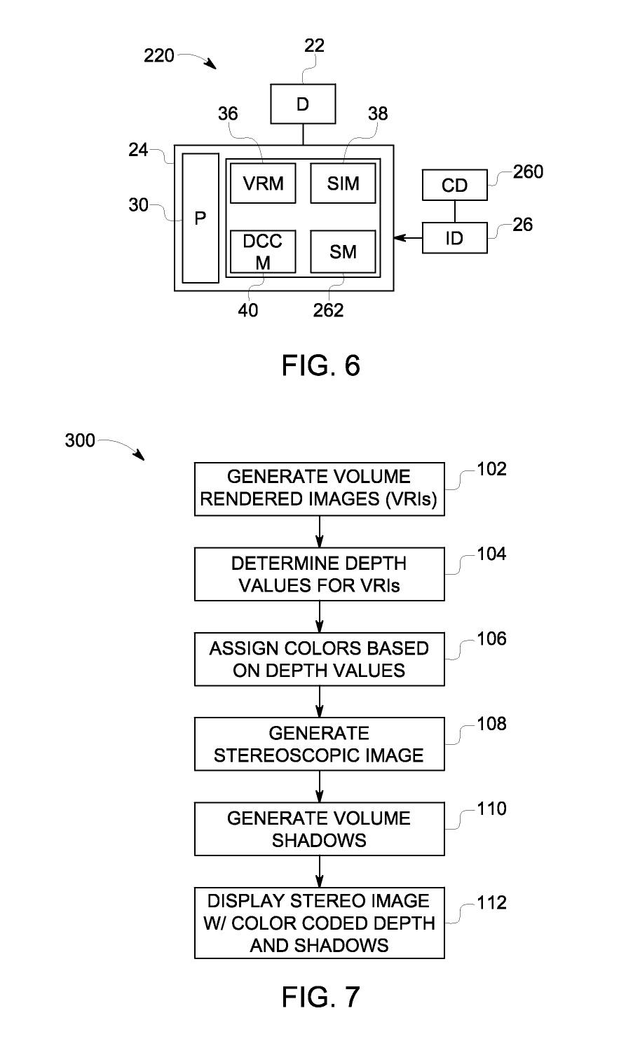

FIG. 6 schematically illustrates stereoscopic volume rendering image system 220, an example implementation of system 20. System 220 is similar to system 20 except that system 220 additionally comprises capture device 260 and shadowing module 262. Those remaining components of system 220 which correspond to components of system 20 are numbered similarly.

Capture device 260 comprises a device configured to capture three-dimensional image data for use by engine 24 to display a stereoscopic image of volume rendered images on display 22. The data obtained by capture device 260 is continuously transmitted to engine 24 which continuously displays stereoscopic images of volume rendered images on display 22 in response to commands or input by a viewer of display 22. In one implementation, capture device 260 comprises a three-dimensional ultrasound probe having a two-dimensional array of ultrasound transducer elements. In other implementations, capture device 260 may comprise other devices to capture three-dimensional data such as x-ray computer tomography (CT) scanners, positron emission tomography (PET) scanners and the like.

Shadowing module 262 comprises programming, software code contained on memory 32 that is configured to add volume shadows to the stereoscopic volume rendered image. Shadowing module 262 cooperates with modules 36, 38 and 42 direct processor 30 to carry out the example stereoscopic volume rendering imaging method 100 shown in FIG. 7. As shown by FIG. 7, method 300 is similar method 107 except that method 300 additionally includes step 110, wherein volume shadows are generated for display in step 112. Those steps of method 300 that correspond to steps of method 100 are numbered similarly.

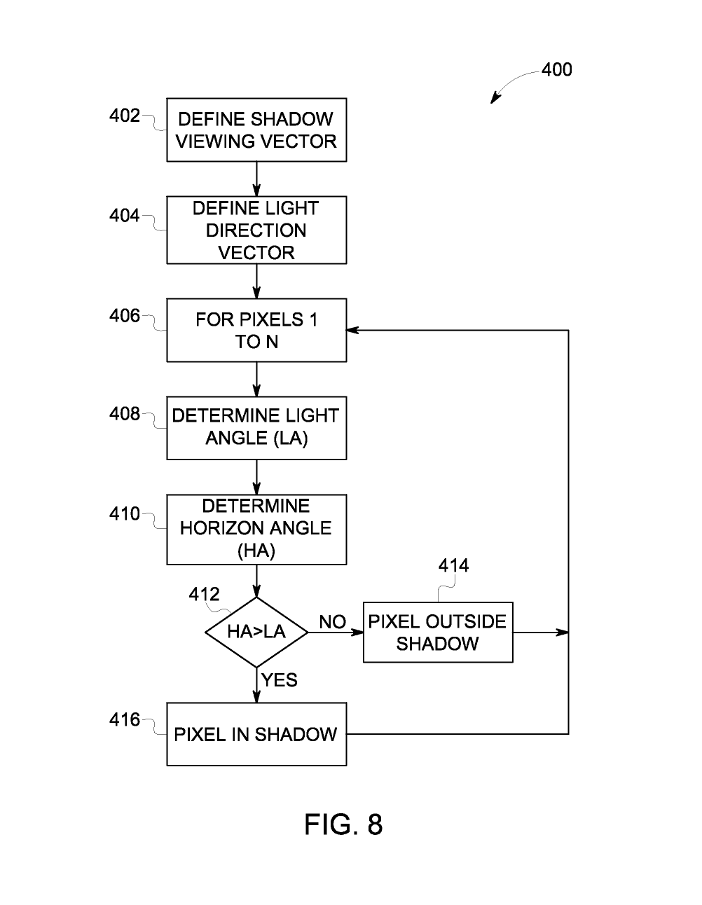

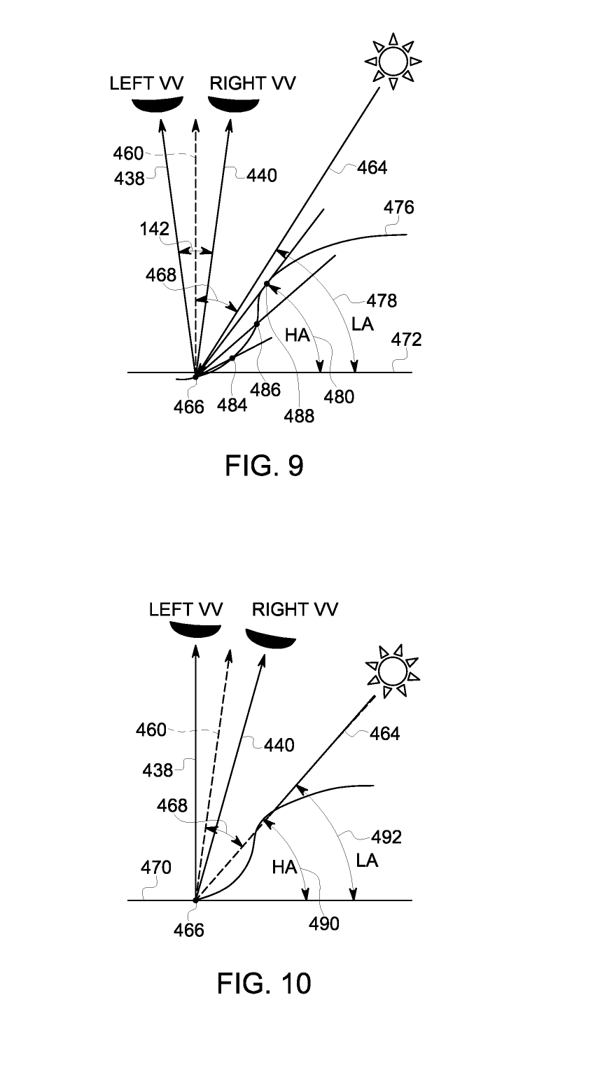

FIG. 8 is a flow diagram illustrating one example method 400 that may be carried out by processor 30 according to instructions provided by shadowing module 262. FIGS. 9 and 10 illustrate an example implementation of method 400. As indicated by step 402, processing unit 30 defines a shadow viewing vector. As shown by FIG. 9, the volume rendered images utilized to form a stereoscopic image comprise a left image taken along a left viewing vector 438 by a left camera and a right image taken along a right viewing vector 440 by a right camera. In the implementation shown in FIG. 9, processing unit 30 defines a shadow viewing vector 460 that lies between vectors 438 and 440. In one implementation, shadow viewing vector 460 comprises a vector equally bisecting the separation angle 142. As a result, the subsequently produced shadowing is more equally defined between the left and right views. For example, an implementation where the separation angle 142 is 4 degrees, processing unit 30, following instructions contained in shadowing module 262, defines the shadow viewing vector 460 as a vector angularly spaced two degrees from each of vectors 438, 440.

As indicated by step 404, processing unit 30 defines a light direction vector. The light direction vector is a vector at which light is directed at the surface for defining shadows. As shown by FIG. 9, shadowing module 262 directs processor 32 define an example like direction vector 464 at a particular voxel or pixel 466. Light direction vector 464 is angularly spaced from shadow viewing vector 460 by fixed angle 468. Fixed angle for 68 remains constant as the left and right cameras (the left and right viewing vectors 438, 440) move. FIG. 10 illustrates the left and right viewing vectors 438, 440 rotated or moved to the right with respect to pixel number 466. To maintain the fixed angle 468, light direction vector 464 also correspondingly moves or rotates about pixel 466. In other words, the light (light direction vector) moves with the viewing vectors (camera) so that the angle 468 between the light and the viewing vectors stays fixed if the viewing vector is changed. As will be described hereafter, such movement of viewing vectors 438, 440 (a change in the viewing direction) may result in changes to shadowing.

As indicated by steps 406-416, for each surface pixel of the stereoscopic image at an existing position of viewing vectors 438, 440, shadowing module 262 directs processor 30 to determine a light angle (step 408) and determine a horizon angle (step 410). FIGS. 9 and 10 illustrate examples of such light and horizon angles. As shown FIG. 9, the example light angle 478 shown is the angle between a horizontal 472 and the light direction vector 464. The horizon angle 480 is the largest angle found between the horizontal 472 and the line extending from pixel 466 through each point along the other surface pixels 476. FIG. 9 illustrates one example of how the horizon angle is identified. For each point along surface 476, processing unit 30 defines a line extending from the particular pixel 466 through the point and further determines the angle between horizontal 472 and the line. FIG. 9 illustrates three such example points along surface 476, points 484, 486 and 488 at which angle are determined. The greatest angle is identified as the horizon angle (HA). In the example illustrated, the horizon angle is a occurring at point 488 along surface 476, angle 480.

As indicated by step 412, the identified horizon angle HA is compared to the light angle. As indicated by step 414, if there horizon angle 480 is not greater than the light angle, the pixel 466 is identified as being outside of any shadow. Alternatively, as indicated by step 416, if the identified horizon angle is greater than the light angle, the particular pixel 466 is identified as being in the shadow. In the example shown in FIG. 9, the horizon angle 480 is less than the light angle 478. As a result, the particular pixel 466 at the particular viewing angle 460 is not identified as being within a shadow. In the example shown in FIG. 10, after the viewing angle is changed (also resulting in the light direction also being changed), the horizon angle 490 is greater than the light angle 492. As a result, the particular pixel 466 is determined to be within the shadow. In other implementations, the determination as to whether a particular pixel is currently within a shadow may be made in other fashions.

Those pixels 466 that are identified by processing unit 30 as being within the shadow are displayed differently by processing unit 30 from those pixels that are identified as not being within the shadow. In one implementation, an intensity and/or color saturation/hue those pixels identified as being within the shadow is changed. One implementation, processing unit 30, under the control of shadowing module 262, reduces the intensity and modifies either color saturation are hue for those pixels in the regions of the volume shadow. In other implementations, the display pixels determined to be within the volume shadow may be visualized in other manners.

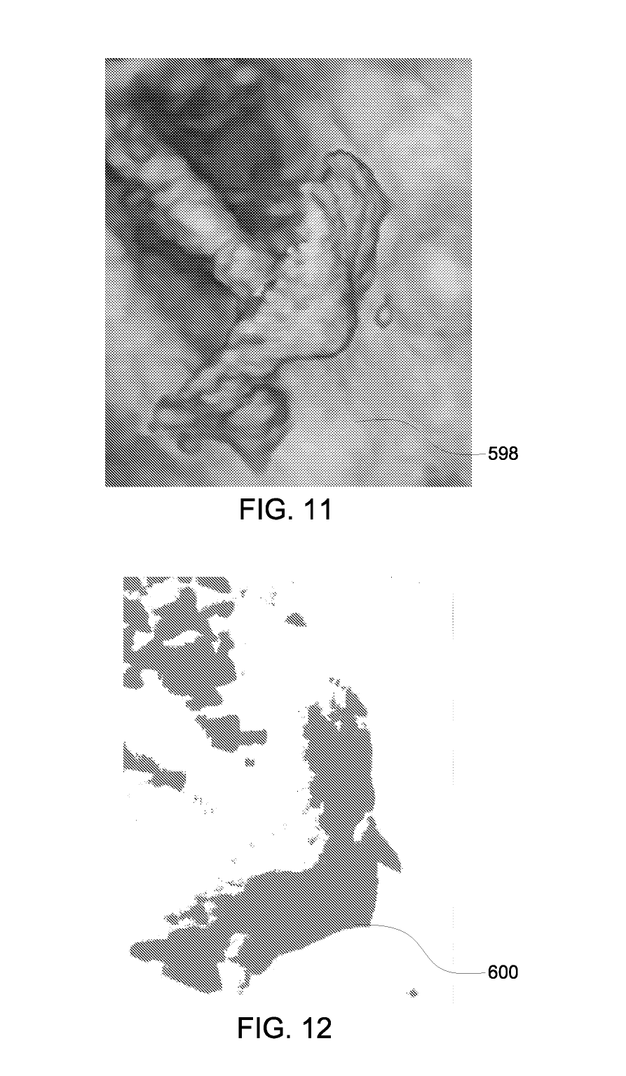

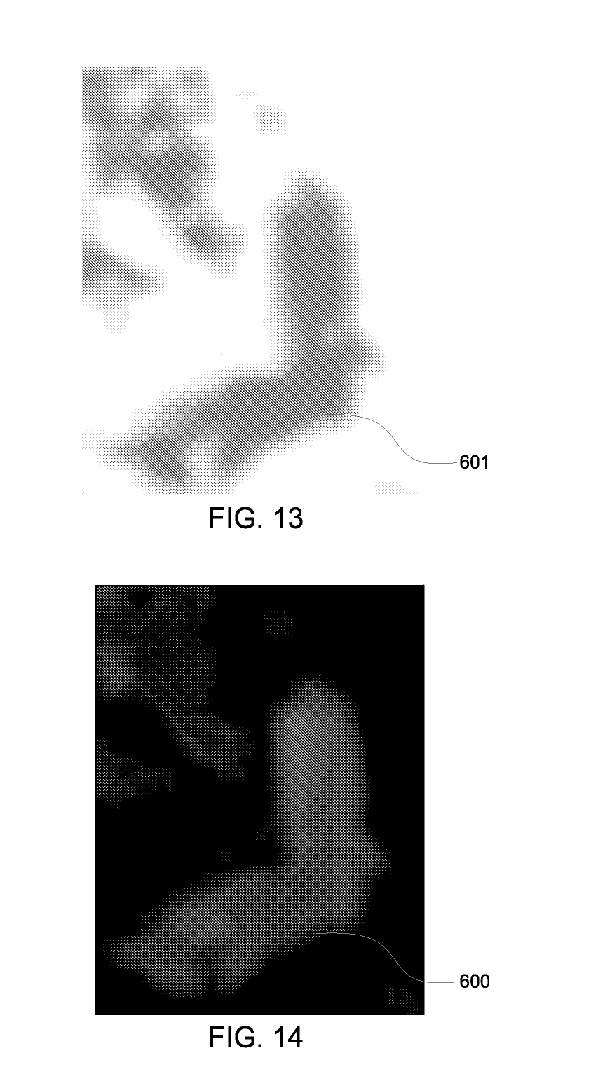

FIGS. 11-15 illustrate an example process for displaying those pixels of the stereoscopic volume rendered image that are determined to lie within a shadow at a particular viewing vector. FIG. 11 illustrates an example stereoscopic image 598 of the volume rendered images. FIG. 12 illustrates those pixels 600 of the stereoscopic image 598 of FIG. 11 that are determined to be within the shadow. Pixels 600 form a shadow buffer. As shown by FIG. 13, the shadow buffer formed by pixels 600 is buffered to form a filtered shadow 601. In one implementation, a Gaussian blurring filter is applied to create a softer shadow 601. In other implementations, other filters may be applied to the shadow shown in FIG. 12. As shown by FIG. 14, the color and intensity of the pixels 600 in the shadow is altered. For example, in one implementation, color value for the pixel in the shadow is multiplied by a factor less than one. In one implementation, the color saturation of the pixels is also increased, darkening the pixels in the shadow.

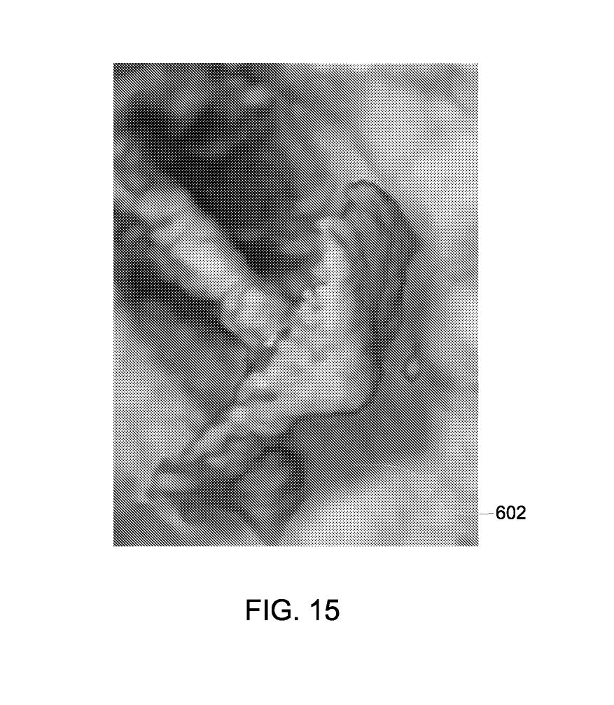

FIG. 15 illustrates a final stereoscopic volume rendered image having shadows 602. Shadows 602 provides additional perception cues. As a result, system 220 facilitates enhanced visualization of the stereoscopic image by physicians or other viewers. Volume shadows are for instance very useful during cardiac interventions as the shadow cast from a cather on the ventricle wall helps the interventionalists to determine the distance between the catheter and the wall during critical procedures.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
generating volume rendered images of internal anatomical imaging data, the volume rendered images being generated along different viewing vectors;
generating a stereoscopic image based on the volume rendered images;
determining depth values for pixels of each of the volume rendered images; and
assigning the pixels with colors based on the determined depth values, wherein the stereoscopic image has color-coded depth representation.

2. The method of claim 1 wherein the viewing vectors of the volume rendered images forming the stereoscopic image have a separation angle of no greater than 4.

3. The method of claim 1 further comprising generating a volume shadow in the stereoscopic image.

4. The method of claim 3 further comprising adjusting a light angle of the volume shadow.

5. The method of claim 3, wherein generating the volume shadow in the stereoscopic image comprises reducing an intensity and modifying one of color saturation or hue for pixels in regions of the volume shadow.

6. The method of claim 3, wherein the generation of the volume shadow is based upon a directed light vector and a shadow viewing vector, wherein the shadow viewing vector angularly bisects a first viewing vector of a first one of the volume rendered images and a second viewing vector of a second one of the volume rendered images.

7. The method of claim 1, wherein the internal anatomical imaging data is ultrasound data.

8. The method of claim 1, wherein generating the stereoscopic image based on the volume rendered images comprises row interlacing of the volume rendered images.

9. A method comprising:
generating volume rendered images of ultrasound data, the volume rendered images being taken along different viewing vectors;
generating a stereoscopic image based on the volume rendered images; and
generating a volume shadow in the stereoscopic image.

10. The method of claim 9, wherein generating the volume shadow in the stereoscopic image comprises reducing an intensity and modifying one of color saturation or hue for pixels in regions of the volume shadow.

11. The method of claim 9, wherein the generation of the volume shadow is based upon a directed light vector and a shadow viewing vector, wherein the shadow viewing vector angularly bisects a first viewing vector of a first one of the volume rendered images and a second viewing vector of a second one of the volume rendered images.

12. An apparatus comprising:
a non-transient computer-readable medium containing programming to direct a processor to:
generating volume rendered images of ultrasound data, the volume rendered images being taken along different viewing vectors;
generating a stereoscopic image based on the volume rendered images;
determining depth values for pixels of each of the volume rendered images; and
assigning the pixels with colors based on the determined depth values, wherein the stereoscopic image has color-coded depth representation.

13. The apparatus of claim 10, wherein the non-transient computer-readable medium further contains programming to direct a processor to generate a volume shadow in the stereoscopic image.

14. The apparatus of claim 13, wherein the generation of the volume shadow is based upon a directed light vector and a shadow viewing vector, wherein the shadow viewing vector is angularly between a first viewing vector of a first one of the volume rendered images and a second viewing vector of a second one of the volume rendered images.

15. The apparatus of claim 12, wherein the shadow viewing vector angularly bisects the first viewing vector and the second viewing vector.

16. The apparatus of claim 10, wherein the different viewing vectors of the volume rendered images have a separation angle of no greater than 4 degrees.

17. An ultrasound display system comprising:
at least one ultrasound transducer to produce ultrasound data signals taken along different viewing vectors;
a display; and
a display controller to:
receive the signals from the ultrasound transducer;
generate volume rendered images based on the signals;
generate a stereoscopic image based on the volume rendered images;
determining depth values for pixels of each of the volume rendered images; and
assigning the pixels with colors based on the determined depth values, wherein the stereoscopic image has color-coded depth representation

18. The ultrasound display system of claim 15, wherein the display controller is configured to generate a volume shadow based upon a directed light vector and a shadow viewing vector, wherein the shadow viewing vector is angularly between the viewing vectors of the ultrasound data signals.

19. The ultrasound display system of claim 15, wherein the at least one ultrasound transducer comprises at least one two-dimensional array of transducer elements.

20. The ultrasound display system of claim 15, wherein the viewing vectors of the ultrasound data signals have a separation angle of no greater than 4 degrees.
